(19) United States
(12) Patent Application Publication
(10) Pub. No.: US 2025/0193939 A1
(43) Pub. Date: Jun. 12, 2025

(54) RANDOM ACCESS CHANNEL OCCASION CONFIGURATIONS FOR RANDOM ACCESS PREAMBLE REPETITIONS

(71) Applicant: QUALCOMM Incorporated, San Diego, CA (US)

(72) Inventors: Hung Dinh LY, San Diego, CA (US); Kexin XIAO, Shanghai (CN); Krishna Kiran MUKKAVILLI, San Diego, CA (US)

(21) Appl. No.: 18/679,082

(22) Filed: May 30, 2024

Related U.S. Application Data
(63) Continuation of application No. PCT/CN2022/078817, filed on Mar. 2, 2022.

(51) Int. Cl. H04W 74/0833; H04W 74/00

(52) U.S. Cl. CPC H04W 74/0833; H04W 74/004

(57) ABSTRACT

A method of wireless communication performed by a user equipment (UE) includes receiving, from a base station (BS), a random access configuration associated with a plurality of random access occasions, wherein at least a first portion of the plurality of random access occasions is configured for PRACH message repetitions. The method further includes transmitting, to the BS based on the random access configuration, at least one random access communication, the at least one random access communication including a plurality of PRACH message repetitions in two or more of the plurality of random access occasions, wherein at least one of a random access occasion index associated with the at least one random access communication or the random access preamble indicates the at least one random access communication includes at least two PRACH message repetitions.

### CROSS-REFERENCE TO RELATED APPLICATIONS

The present application is a 35 U.S.C. § 371 National Stage application of PCT Application No. PCT/CN2022/078817, filed Mar. 2, 2022, the entirety of which is incorporated by reference herein.

### TECHNICAL FIELD

The present disclosure is directed to wireless communication systems and methods. Certain aspects can enable and provide techniques for random access preamble transmissions in idle periods of frame based equipment (FBE) frames.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5th Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHZ, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

To initiate, or re-initiate communications on a network, a UE and a BS may perform a random access channel (RACH) procedure. In the RACH procedure, the UE may detect one or more synchronization signal blocks (SSBs) associated with one or more spatial directional filters or beam directions. The UE may also perform channel strength and/or quality measurements to determine whether to initiate communications on a cell. Based on at least one SSB, the UE transmits a RACH preamble to initiate the RACH sequence. RACH procedures may be four-step procedures (RACH type-1) or two-step procedures (RACH type-2). The RACH preamble is transmitted in a physical random access channel (PRACH). The BS monitors for the RACH preamble using a set of configured time-frequency resources referred to as RACH occasions. Each RACH occasion may be associated with a RACH occasion (RO) index and includes a set of time-frequency resources for monitoring for PRACH MSG1 transmissions.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

According to one aspect of the present disclosure, a method for wireless communication performed by a user equipment (UE) includes: receiving, from a base station (BS), a random access configuration associated with a plurality of random access occasions, wherein at least a first portion of the plurality of random access occasions is configured for random access preamble repetitions; and transmitting, to the BS based on the random access configuration, at least one random access communication, the at least one random access communication including a plurality of PRACH message repetitions in two or more of the plurality of random access occasions, wherein at least one of a random access occasion index associated with the at least one random access communication or the random access preamble indicates the at least one random access communication includes at least two repetitions of the random access preamble.

According to another aspect of the present disclosure, a method for wireless communication performed by a base station (BS) includes: transmitting, to a user equipment (UE), a random access configuration associated with a plurality of random access occasions, wherein at least a first portion of the plurality of random access occasions is configured for random access preamble repetitions; and receiving, from the UE based on the random access configuration, at least one random access communication the at least one random access communication including a plurality of PRACH message repetitions in two or more of the plurality of random access occasions, wherein at least one of a random access occasion index associated with the at least one random access communication or the random access preamble indicates the at least one random access communication includes at least two repetitions of the random access preamble.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a radio frame structure according to some aspects of the present disclosure.

FIG. 3A illustrates a random access occasion configuration, according to some aspects of the present disclosure.

FIG. 3B illustrates a random access occasion configuration, according to some aspects of the present disclosure.

FIG. 3C illustrates a random access occasion configuration, according to some aspects of the present disclosure.

FIG. 4 is a signaling diagram illustrating a method for indicating a random access preamble transmission with repetitions, according to some aspects of the present disclosure.

FIG. 5 illustrates a random access occasion configuration for indicating a random access preamble transmission with repetitions, according to some aspects of the present disclosure.

FIG. 6 illustrates a random access occasion configuration for indicating a random access preamble transmission with repetitions, according to some aspects of the present disclosure.

FIG. 7 illustrates a random access occasion configuration for indicating a random access preamble transmission with repetitions, according to some aspects of the present disclosure.

FIG. 8 illustrates a random access occasion configuration for indicating a random access preamble transmission with repetitions, according to some aspects of the present disclosure.

FIG. 9 is a block diagram of an exemplary user equipment (UE) according to some aspects of the present disclosure.

FIG. 10 is a block diagram of an exemplary base station (BS) according to some aspects of the present disclosure.

FIG. 11 is a flow diagram of a wireless communication method according to some aspects of the present disclosure.

FIG. 12 is a flow diagram of a wireless communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI). Additional features may also include having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHZ, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHZ band, the subcarrier spacing may occur with 60 kHz over a 160 MHz BW. Finally, for various deployments transmitting with mm Wave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

In a cellular wireless communication network, a UE may request a connection setup to the network, commonly referred to as random access. The random access plays three main roles, including: (i) establishment of a radio link and uplink synchronization for initial access, (ii) to re-establish a radio link after radio-link failure, and/or (iii) for handover when uplink synchronization needs to be established to the new cell. The UE may initiate a random access procedure in an uplink Random Access Channel (RACH). The first step in the random access procedure may be the transmission of a random access preamble. A purpose of the preamble transmission is to notify the BS of a random access attempt by a UE and to allow the BS to estimate the delay between the BS and the UE. The delay estimate will be used to adjust the uplink timing.

The time frequency resources on which the random access preamble is transmitted is known as the Physical Random Access Channel (PRACH). The network broadcasts information regarding the time-frequency resources (PRACH resources) for the preamble transmission on Downlink Physical Broadcast Channel (DL-PBCH). For instance, the PRACH information may be informed to the UEs via System Information Block (SIB) (e.g., a SIB 2). In the random access procedure, the UE may detect one or more synchronization signal blocks (SSBs) associated with one or more spatial directional filters or beam directions. The UE may also perform channel strength and/or quality measurements to determine whether to initiate communications on a cell. The UE may also select one or more SSBs or spatial directional filters to transmit the RACH preamble. Based on the selected one or more SSBs, the UE transmits a RACH preamble to initiate the RACH sequence.

In some aspects, there is an association between the set of SSBs and the PRACH resources. For instance, each SSB of the set of SSBs may be identified by an SSB index and may be mapped or associated with corresponding PRACH resources. The PRACH resources may also be referred to as random access channel (RACH) occasions or random access occasions (ROs). In some instances, the associations between SSBs and PRACH resources may be broadcast to UEs by the BS (e.g., in a SIB, such as a SIB 2). The association between SSBs and PRACH resources can be useful when the BS transmits different SSBs in the set of SSBs in different beam directions, for example, when operating in frequency range 1 (FR1) and/or in frequency range 2 (FR2). For instance, the BS may monitor for a random access preamble in an RO in a same beam direction as where an SSB associated with the RO is transmitted. Thus, a UE detecting a certain SSB in a certain beam direction may transmit a random access preamble in an RO associated with the SSB using a beam direction corresponding to the beam direction of the received SSB.

In some instances, a UE may determine to transmit multiple repetitions of a PRACH MSG1 to increase the chances that the preamble is detected by the BS. For the purposes of the present disclosure, a repetition of a PRACH MSG1 transmission may be referred to as a PRACH repetition. Accordingly, a UL communication including multiple PRACH MSG1 repetitions may be referred to as a multiple-PRACH transmission. In some aspects, each PRACH repetition of the multiple-PRACH transmission may be transmitted in a respective RO. Each PRACH repetition may include one or more instances of a RACH preamble sequence. For example, a single PRACH repetition may include a single instance of a RACH preamble sequence, or multiple copies or repetitions of the RACH preamble sequence. In some aspects, if the UE obtains low RSRP measurements of the SSBs, the UE may determine to transmit multiple PRACH transmissions. The UE may transmit one instance of the PRACH, or one PRACH transmission, in one RO. Because transmitting a single PRACH transmission or multiple repetitions of the PRACH is based on UE measurements, the receiving BS may not know whether a PRACH received in an RO is a single PRACH, or part of a multiple-PRACH transmission. Accordingly, detecting multi-PRACH transmissions may involve applying multiple detection hypotheses for a PRACH, for example, a single PRACH hypothesis and a multi-PRACH hypothesis across multiple ROs. Further, if the BS incorrectly determines that a PRACH is a single PRACH, the BS may erroneously transmit a random access response (RAR) with a random access radio network temporary identifier (RA-RNTI) based on the single received RO, which may be rejected by the UE. This may lead to delays in the UE accessing the network, higher power consumption, and/or a waste of network resources. These issues may be exacerbated if PRACH repetitions with multiple spatial filters are configured.

The present disclosure describes configurations and mechanisms for random access with PRACH repetitions. A BS may configure a UE with a random access configuration associated with a plurality of RACH occasions (ROs). In some aspects, at least a portion of the plurality of random access occasions are configured for PRACH MSG1 repetitions, which may be referred to as PRACH repetitions. The UE may determine to initiate a RACH procedure to request uplink (UL) resources, such as PUSCH resources. The UE may transmit, to the BS based on the random access configuration, a RACH communication including plurality of PRACH repetitions in a plurality of ROs. The RACH communication may be associated with a preamble index. In some aspects, the RACH communication may indicate, to the BS, whether the RACH communication includes a single PRACH transmission, or a plurality of PRACH repetitions. In some aspects, the ROs in which the RACH communication is transmitted may indicate whether the RACH communication includes a plurality of PRACH repetitions or a single PRACH transmission. For example, the random access configuration may indicate a first set of ROs configured for PRACH repetitions and a second set of ROs configured for single PRACH transmissions. In another aspect, the RACH preamble index of the RACH communication may indicate whether the RACH communication includes a plurality of PRACH repetitions, or a single PRACH transmission. For example, the random access configuration may indicate a first set of RACH preamble indexes associated with PRACH repetitions, and a second set of RACH preamble indexes associated with single PRACH transmissions. Based on the detected RO and/or the preamble index, the BS may determine whether the detected RACH preamble is associated with a single PRACH transmission, or a plurality of PRACH repetitions.

In another aspect, at least one of the RO or the RACH preamble index detected by the BS may indicate whether the RACH communication includes PRACH repetitions mapped using a same spatial filter or whether the RACH communication includes PRACH repetitions mapped using different spatial filters. For example, the RO and/or the RACH preamble index may indicate to the BS that the RACH communication includes two or more PRACH repetitions all transmitted using a same first spatial filter. In another example, the RO and/or the RACH preamble index may indicate to the BS that the RACH communication includes two or more PRACH repetitions transmitted using at least a first spatial filter and a second spatial filter (different than the first spatial filter). In some aspects, the random access configuration may indicate a first set of ROs configured for PRACH repetitions using two or more different SSB indexes, and a second set of ROs configured for PRACH repetitions using a single SSB index. In another example, the random access configuration may indicate a first set of RACH preamble indexes associated with PRACH repetitions using two or more different SSB indexes and a second set of RACH preamble indexes associated with PRACH repetitions using a single SSB index.

Aspects of the present disclosure can provide several benefits. For example, allowing a UE to transmit multiple repetitions of a PRACH MSG1, or multiple instances of a PRACH, may increase the probability that the RACH preamble is detected by the BS. This may reduce latency and improve efficiency. Allowing a UE to transmit multiple repetitions of the PRACH using different spatial filters may further improve the probability that a RACH preamble is detected. Further, configuring a UE to indicate whether a RACH communication includes multiple PRACH repetitions or a single PRACH transmission may allow the BS to correctly detect the RACH communication using fewer detection hypotheses, which may reduce power consumption at the BS and reduce the complexity of the RACH process. Accordingly, the RACH process may be more robust and efficient, reducing latency and improving user experience.

As used herein, the terms “random access occasions” and “RACH occasions” may be used interchangeably. As described herein, the terms “PRACH MSG1 repetitions,” “PRACH message repetitions,” “repetitions of MSG1 instances,” and “PRACH repetitions” may be used interchangeably.

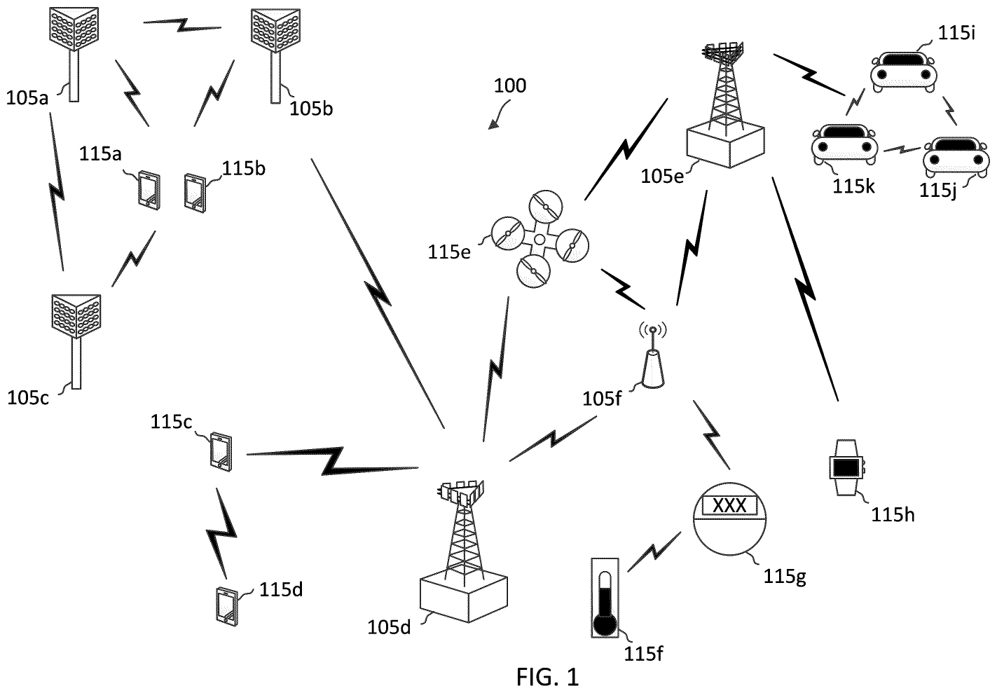

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105c, and 105f) and other network entities. A BS 105 may be a station that communicates with UEs 115 and may also be referred to as an evolved node B (CNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115c-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115c may include links from the macro BSs 105d and 105c, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105c, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

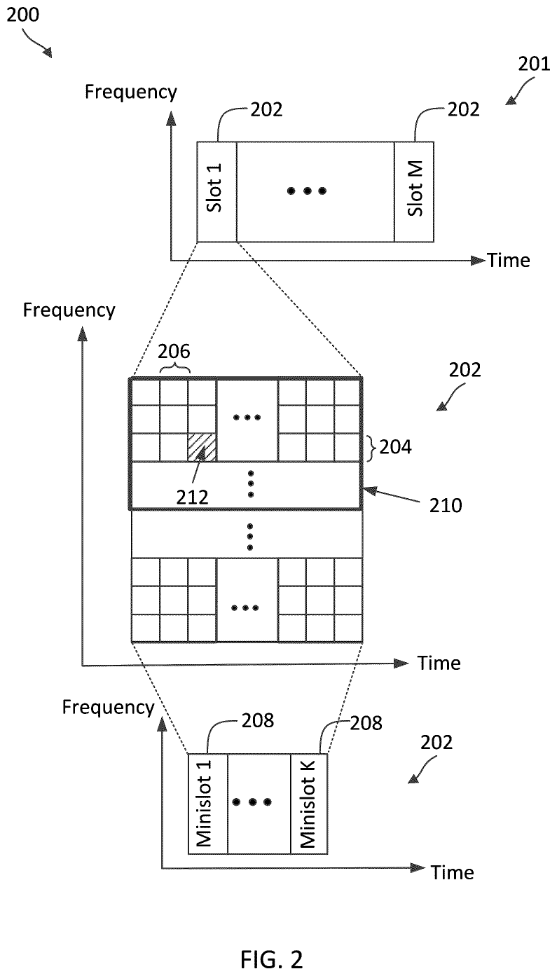

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots as will be discussed more fully below in relation to FIG. 2. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 may initiate an initial network attachment procedure with the network 100. When the UE 115 has no active data communication with the BS 105 after the network attachment, the UE 115 may return to an idle state (e.g., RRC idle mode). Alternatively, the UE 115 and the BS 105 can enter an operational state or active state, where operational data may be exchanged (e.g., RRC connected mode). For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the BS 105 may transmit a PRACH configuration to the UE 115. The PRACH configuration may indicate a set of ROs in the PRACH configuration. The BS 105 and/or the UE 115 may divide ROs into different groups, including a first group of ROs configured for PRACH repetitions, and a second group configured for single PRACH transmissions.

FIG. 2 illustrates a transmission radio frame structure 200 according to some aspects of the present disclosure. The radio frame structure 200 may be employed by BSs such as the BSs 105 and UEs such as the UEs 115 in a network such as the network 100 for communications. In FIG. 2, the x-axes represent time in some arbitrary units and the y-axes represent frequency in some arbitrary units. The transmission frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel bandwidth, the subcarrier spacing (SCS), and/or the CP mode. One subcarrier 204 in frequency and one symbol 206 in time forms one resource clement (RE) 212 for transmission. A resource block (RB) 210 is formed from a number of consecutive subcarriers 204 in frequency and one or more consecutive symbols 206 in time. In NR, a RB 210 is defined as twelve consecutive subcarriers 204 in a frequency domain.

In an example, a BS (e.g., BS 105 in FIG. 1) may schedule a UE (e.g., UE 115 in FIG. 1) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N−1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204).

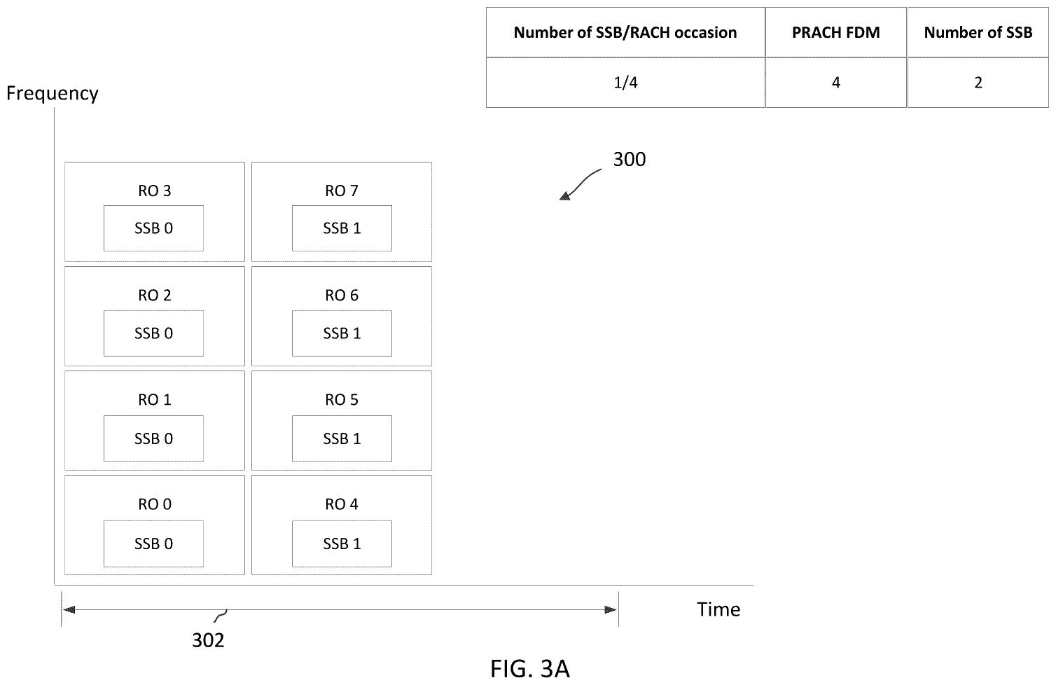

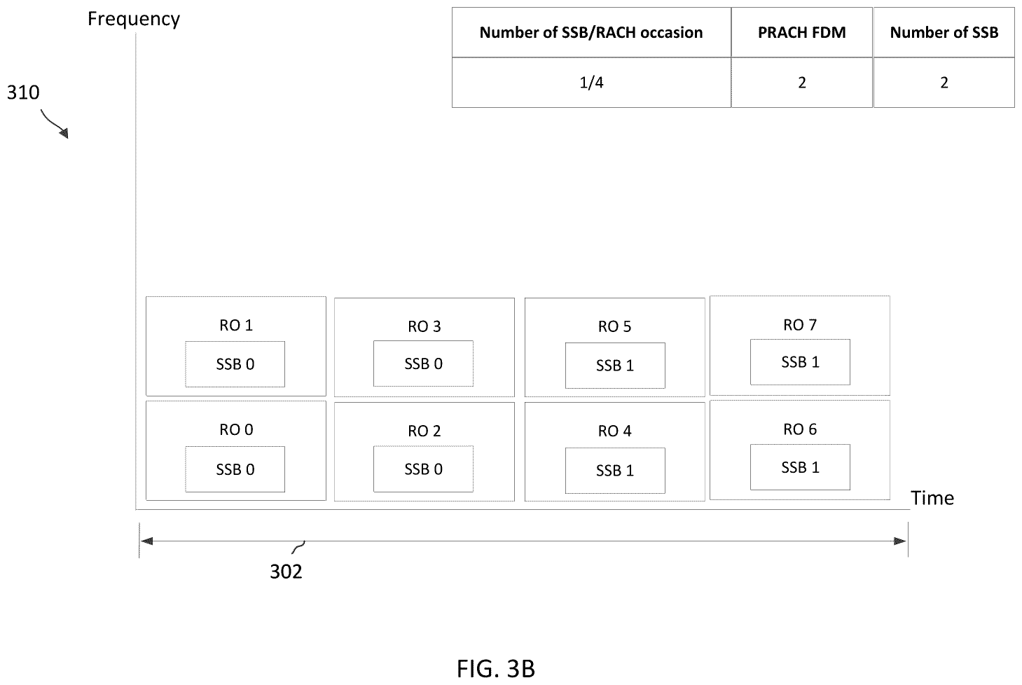

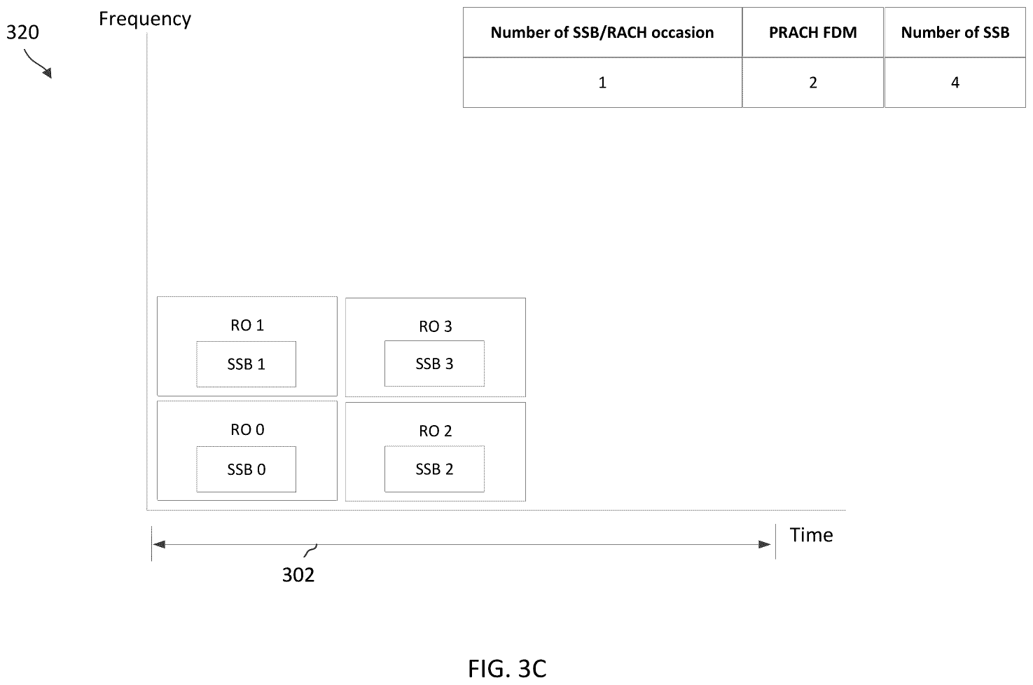

FIGS. 3A-3B illustrate PRACH configuration schemes 300, 310, 320 associated with a plurality of RACH occasions (ROs). The PRACH configurations of the schemes 300, 310, 320 may be configured using RRC signaling. The PRACH configurations may include or indicate a plurality of parameters or fields. For example, the PRACH configurations may indicate a number of SSB indexes corresponding to each of one or more ROs in an association period. As shown in FIGS. 3A-3C, the PRACH configurations may indicate a number of SSBs or spatial filters per each RO, the number of PRACH frequency domain multiplexed (FDM) in the association period, and the number of SSBs mapped to the ROs in the association period. The number of SSBs/RO may be a fractional value (e.g., ⅛, ¼, ½), 1, or an integer greater than one (e.g., 1, 2, 4, 8). The SSB indexes may be mapped to the ROs first, in increasing order of preamble indexes within a single RACH occasion; second, in increasing order of frequency resource indexes for frequency multiplexed (FDM) RACH occasions; third, in increasing order of time resource indexes for time multiplexed RACH occasions within a PRACH slot; and fourth, in increasing order of indexes for PRACH slots.

Referring to FIG. 3A, a random access configuration scheme 300 is illustrated according to an aspect of the present disclosure. The configuration includes, as explained above, a number of SSB/RO, a number of FDM PRACH, and a number of SSB indexes in an association period 302. The association period 302 may include at least a portion of a RACH slot. In the illustrated example, the number of SSB/RO is ¼. Accordingly, SSB 0 is mapped to four ROs, in ascending order in the frequency domain. The number of FDM PRACH is 4. Accordingly, all four of the instances of SSB 0 are mapped to a first set of time resources including the first four ROs, RO 0-RO 3. SSB 1 is mapped to the following four ROs (RO 4-RO 7), also in ascending order in the frequency domain, and in a set of time resources following the time resources of ROs 0-4. The configuration also indicates that two SSB indexes are mapped, including SSB 0 and SSB 1. Accordingly, the total number of mapped ROs within the association period is 8.

Referring to FIG. 3B, a random access configuration scheme 310 is illustrated according to another aspect of the present disclosure. In the illustrated example of FIG. 3B, the number of SSB/RO is ¼. Accordingly, SSB 0 is mapped to four ROs, in ascending order in the frequency domain, and then in ascending order in the time domain. The number of FDM PRACH is 2. Accordingly, the first two instances of SSB 0 are mapped to a first set of time resources including the first two ROs, RO 0 and RO 1, and the second two instances of SSB 0 are mapped to a second set of time resources including the third and fourth ROs, RO 2 and RO 3. SSB 1 is mapped to the following four ROs (RO 4-RO 7), first in ascending order in the frequency domain, and then in ascending order in the time domain. The configuration also indicates that two SSB indexes are mapped, including SSB 0 and SSB 1. Accordingly, the total number of mapped ROs within the association period is 8.

Referring to FIG. 3C, a random access configuration scheme 320 is illustrated according to another aspect of the present disclosure. In the illustrated example of FIG. 3C, the number of SSB/RO is 1. Accordingly, each SSB is mapped to one corresponding RO. The number of FDM PRACH is 2. The number of SSBs is 4. Accordingly, SSB 0 and SSB 1 are mapped to a first set of time resources including the first two ROs, RO 0 and RO 1, in ascending order in the frequency domain. SSBs 2 and 3 are mapped to a second set of time resources including the third and fourth ROs, RO 2 and RO 3. Accordingly, the total number of mapped ROs within the association period is 4.

As explained above, the parameters for the random access configurations illustrated in the schemes 300, 310, 320 may be provided by RRC signaling, and/or via system information blocks (e.g., SIB1, SIB2, MIB, etc.) in some aspects. For example, the number of SSB/RO and the number of preambles per SSB may be provided by ssb-perRACH-OccasionANDCB-PreamblesPerSSB indicated in RACH-ConfigCommon. The number of ROs frequency multiplexed (FDM) may be provided by MSG1-FDM in RACH-ConfigGeneric, for example. The number of SSBs mapped to a set of ROs in an association period may be provided by ssb-PositionsInBurst in SIB1 or in ServingCellConfigommon, for example. In other aspects, one or more of the parameters may be provided by media access control (MAC) information elements or control elements, downlink control information (DCI), and/or any other suitable form of communication.

In some aspects, the SSB or SSBs used by the UE to transmit a RACH preamble may be determined based on RSRP measurements of an SSB burst transmitted by the BS. For example, the UE may select one or more SSBs based on the RSRP and select the ROs which correspond to the selected SSB(s). The UE then transmits a PRACH MSG1 indicating the RACH preamble based on a spatial filter associated with the one or more selected SSBs. The BS may use the same one or more SSBs associated with the PRACH transmission to transmit the RAR (e.g., MSG2, MSGB) in either the four-step or two-step RACH procedure. In the four-step RACH procedure, the UE may use the same SSBs/spatial filters used for the PRACH transmission(s) to transmit the connection request (MSG3).

In some instances, a UE may determine to transmit multiple repetitions of a PRACH MSG1 to increase the chances that the PRACH MSG1 is detected by the BS. For example, if the UE is at or near an edge of a serving cell, the UE may obtain low RSRP measurements of an SSB burst. Accordingly, the UE may determine to transmit multiple PRACH transmissions, which may be referred to as PRACH repetitions, or instances of a PRACH MSG1. The UE may transmit one instance of a PRACH MSG1, or one PRACH repetition, in one RO. Because transmitting a single PRACH MSG1 or multiple PRACH MSG1 repetitions is based on UE measurements, the receiving BS may not know whether a PRACH received in an RO is associated with a single PRACH, or part of a multiple-PRACH transmission. Accordingly, detecting multi-PRACH transmissions may involve applying multiple detection hypotheses for a PRACH, for example, a single PRACH hypothesis and a multi-PRACH hypothesis across multiple ROs. Further, if the BS incorrectly determines that a PRACH is a single PRACH, the BS may erroneously transmit a random access response (RAR) with an RA-RNTI based on the single received RO, which may be rejected by the UE. This may lead to higher power consumption and a waste of network resources. These issues may be exacerbated if PRACH repetitions with multiple spatial filters (SSBs) are configured.

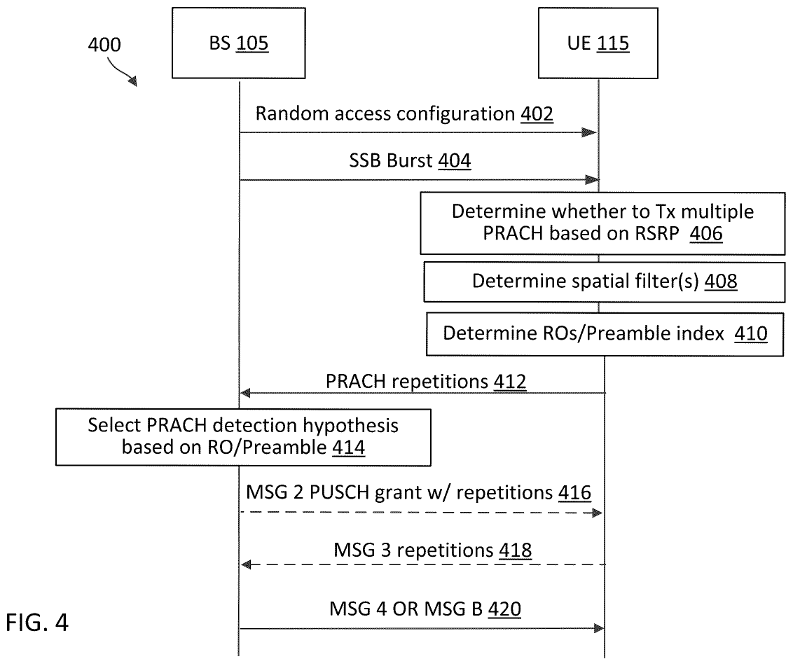

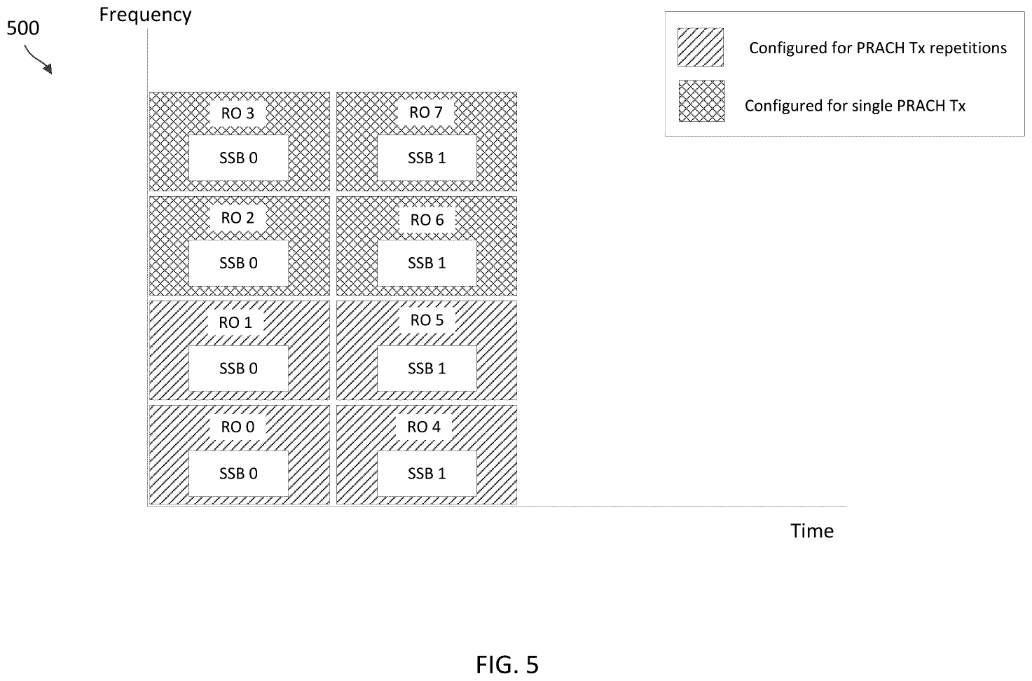

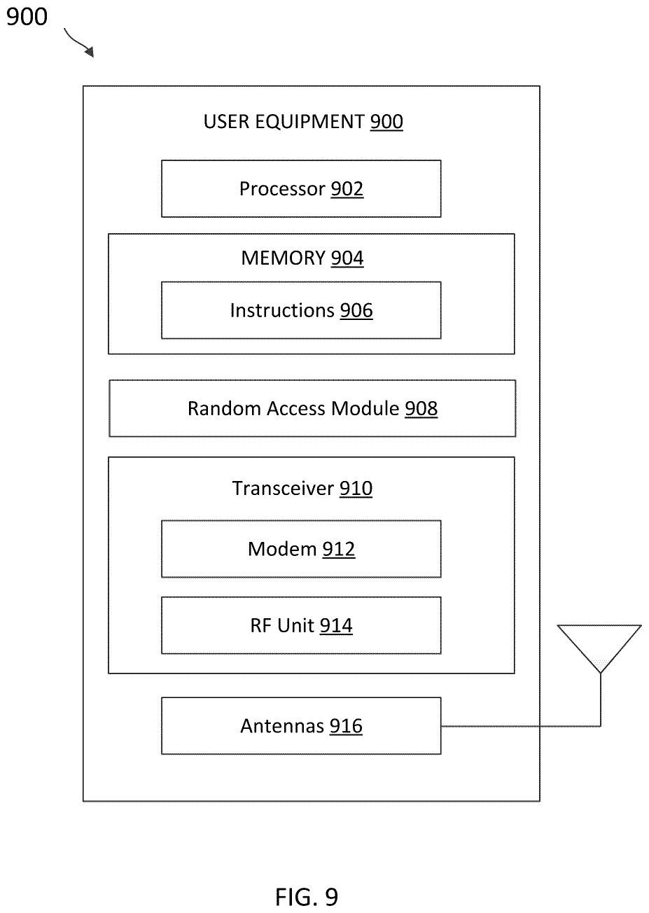

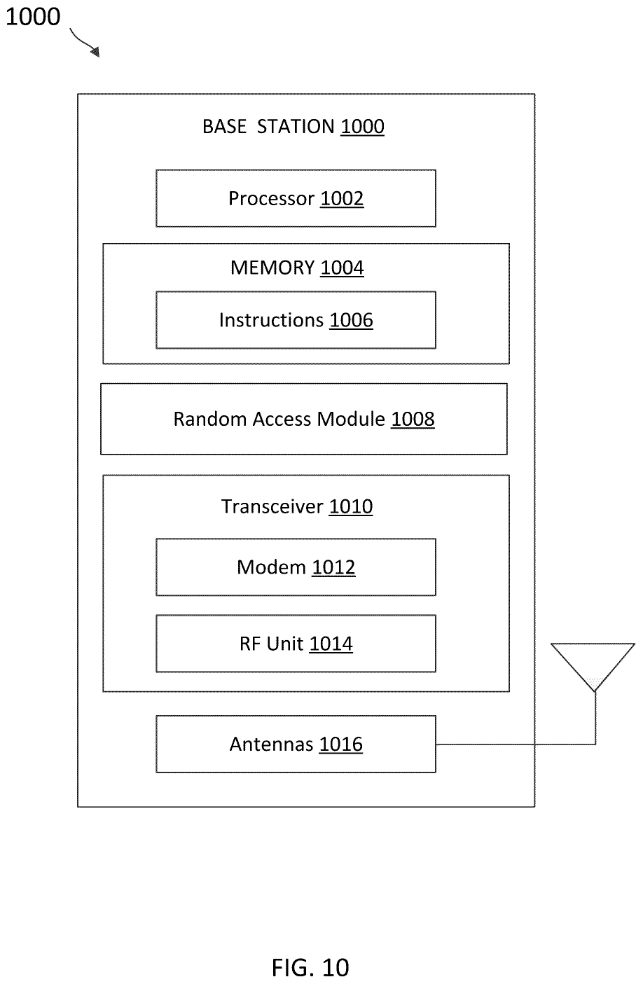

The present disclosure describes configurations, schemes, and mechanisms for random access with PRACH repetitions, which may also be referred to as PRACH MSG1 repetitions, PRACH MSG1 instances, or repetitions of PRACH transmissions. In this regard, FIGS. 4-8 illustrate a wireless communication method 400 for transmitting PRACH repetitions according to various aspects of the disclosure. FIG. 4 is a signaling diagram of the method 400. It will be understood that the method 400 may be used in a four-step RACH procedure (type-1) or a two-step RACH procedure (type-2). FIGS. 5-8 illustrate exemplary aspects of the method 400, including random access configurations for mapping and indicating PRACH repetitions. The method 400 may be performed by, for example, a UE and a BS. The UE may be one of the UEs 115 in the network 100, for example. The BS may be one of the BSs 105 in the network 100. In another aspect, the UE 115 may include the UE 900 illustrated in FIG. 9. In another aspect, the BS 105 may include the BS 1000 illustrated in FIG. 10. In some aspects, the method 400 includes transmitting a RACH communication indicating a RACH preamble associated with a RACH preamble index, where the RACH communication indicates, to the BS 105, whether the RACH communication includes multiple PRACH repetitions, or a single PRACH transmission.

Referring to FIG. 4, at step 402 of the method 400, the BS 105 transmits, and the UE 115 receives, a random access configuration. In some aspects, transmitting the random access configuration may include transmitting system information, such as a master information block (MIB) and/or system information blocks, including SIB 1, SIB 2, and/or any other suitable system information. In another aspect, transmitting the random access configuration may include transmitting one or more RRC messages indicating the parameters of the random access configuration. For example, the random access configuration may include or indicate the time resources (e.g., slots, frames, symbols, etc.) associated with one or more association periods, a number of SSB indexes per RACH occasion (RO), a number of SSBs mapped in the association period, a number of ROs frequency multiplexed (FDM) in the association period, the number of preambles for each SSB. For example, the number of SSB/RO and the number of preambles per SSB may be provided by ssb-perRACH-OccasionANDCB-PreamblesPerSSB indicated in RACH-ConfigCommon. The number of ROs frequency multiplexed may be provided by MSG1-FDM in RACH-ConfigGeneric, for example. The number of SSBs mapped to a set of ROs in an association period may be provided by ssb-PositionsInBurst in SIB1 or in ServingCellConfigommon, for example. In other aspects, one or more of the parameters may be provided by media access control (MAC) information elements or control elements, and/or by downlink control information (DCI).

In another aspect of the present disclosure, the random access configuration may indicate a first set of one or more ROs configured for PRACH repetitions. The random access configuration may also indicate a second set of one or more ROs configured for single PRACH transmissions. For example, the random access configuration may include or indicate one or more parameters or fields indicating one or more RO indexes associated with PRACH repetitions. The random access configuration may indicate, for each SSB, a subset of ROs corresponding to the SSB configured for PRACH repetitions. In another aspect, the random access configuration may indicate an integer value L associated with the number of ROs, for each SSB, configured for PRACH transmissions. For example, the value L may indicate that the first L ROs corresponding to SSB N are configured for PRACH repetitions, or that the last L ROs corresponding to SSB N are configured for PRACH repetitions.

In another aspect, the random access configuration may indicate a first set of one or more RACH preamble indexes associated with PRACH repetitions. The random access configuration may also indicate a second set of one or more RACH preamble indexes associated with single PRACH transmissions. For example, the random access configuration may include or indicate one or more parameters or fields indicating one or more RACH preamble indexes associated with PRACH repetitions.

In another aspect, the random access configuration may indicate a first set of one or more ROs configured for PRACH repetitions using more than one spatial filter or SSB. The random access configuration may also indicate a second set of one or more ROs configured for PRACH repetitions using a single spatial filter or SSB. For example, the random access configuration may include or indicate one or more parameters or fields indicating one or more RO indexes associated with PRACH repetitions that can be transmitted using two or more spatial filters.

In another aspect, the random access configuration may indicate a first set of one or more RACH preamble indexes associated with PRACH repetitions using more than one spatial filter or SSB. The random access configuration may also indicate a second set of one or more RACH preamble indexes associated with PRACH repetitions using a single spatial filter or SSB. For example, the random access configuration may include or indicate one or more parameters or fields indicating one or more RACH preamble indexes associated with PRACH repetitions that can be transmitted using two or more spatial filters.

It will be understood that the random access configuration may be associated with a single transmission or message, or with multiple transmissions or messages. For example, the random access configuration may include a plurality of parameters indicated in an MIB, one or more SIBs, one or more RRC information elements, one or more MAC information elements, one or more MAC control elements, and/or one or more DCIs.

At step 404, the BS 105 transmits, and the UE 115 receives, a burst of synchronization signal blocks (SSBs). The SSB burst may include a plurality of SSB signals associated with a plurality of spatial filters. For example, each SSB may be associated with an SSB index indicating a spatial or directional filter for that signal.

At step 406, the UE 115 determines, based on the SSB burst transmitted at step 404, whether to transmit multiple PRACH. For example, the UE 115 may obtain RSRP measurements of each SSB in the burst, and determine whether the RSRP is above or below a threshold. If the RSRP is below the threshold, which may indicate low signal strength (e.g., UE 115 is at or near an edge of the serving cell), the UE 115 may determine to transmit multiple PRACH repetitions to increase the probability that the PRACH is detected by the BS 105.

Further, the UE 115 determines, based on the SSB burst, one or more spatial filters or SSB indexes for transmitting the one or more PRACH. For example, the UE 115 may obtain RSRP of each SSB in the burst, and determine or select one or more SSBs with relatively higher RSRP measurements. In some aspects, selecting multiple SSBs may further increase the probability that the PRACH is detected by the BS 105.

At step 410, the UE determines or selects, based on the random access configuration transmitted at step 402, at least one of a set of ROs, or one or more preamble indexes for the PRACH. For example, if the UE 115 determines to transmit multiple repetitions of the PRACH at step 406, the UE may select a plurality of ROs configured for PRACH repetitions. The ROs configured for PRACH repetitions may be indicated in the random access configuration. For example, the random access configuration may indicate a subset of ROs for each SSB configured for PRACH repetitions. The UE 115 may select one or more subsets of ROs corresponding to the SSBs selected at step 408. In some aspects, the random access configuration may include or indicate a table of RO indexes, SSB indexes, and/or other parameters that are associated with or configured for PRACH repetitions.

In another example, the UE may select one or more RACH preamble indexes associated with PRACH repetitions. The RACH preamble indexes associated with PRACH repetitions may be indicated in the random access configuration. For example, the random access configuration may indicate a subset of RACH preamble indexes configured for PRACH repetitions. In some aspects, the random access configuration may indicate, for each SSB index, one or more subsets of RACH preamble indexes configured for PRACH repetitions. The UE 115 may select one or more RACH preamble indexes corresponding to the SSBs selected at step 408. In some aspects, the random access configuration may include or indicate a table of RACH preamble indexes, SSB indexes, and/or other parameters that are associated with or configured for PRACH repetitions.

In a further aspect, step 410 may include selecting one or more ROs and/or RACH preamble indexes to indicate whether the random access communication includes PRACH repetitions associated with a single spatial filter, or PRACH repetitions associated with a plurality of spatial filters. For example, if the UE 115 determines to transmit multiple repetitions of the PRACH at step 406, and the UE 115 determines to transmit the PRACH repetitions using more than one spatial filter at step 408, the UE 115 may select a plurality of ROs configured for PRACH repetitions using two or more spatial filters. The ROs configured for PRACH repetitions with two or more spatial filters may be indicated in the random access configuration. For example, the random access configuration may indicate a subset of ROs for each SSB configured for PRACH repetitions with multiple spatial filters. The UE 115 may select one or more subsets of ROs corresponding to the SSBs selected at step 408. In some aspects, the random access configuration may include or indicate a table of RO indexes, SSB indexes, and/or other parameters that are associated with or configured for PRACH repetitions using multiple spatial filters. In another aspect, the table may indicate RO indexes, SSB indexes, and/or other parameters that are associated with or configured for PRACH repetitions using a single spatial filter.

In another example, the UE may select one or more RACH preamble indexes associated with PRACH repetitions transmitted using multiple spatial filters, or a single spatial filter. The RACH preamble indexes associated with PRACH repetitions using multiple spatial filters and/or single spatial filters may be indicated in the random access configuration. For example, the random access configuration may indicate a subset of RACH preamble indexes configured for PRACH repetitions using multiple spatial filters. In some aspects, the random access configuration may indicate, for each SSB index, one or more subsets of RACH preamble indexes configured for PRACH repetitions using multiple spatial filters, and/or using single spatial filters.

At step 412, the UE 115 transmits, based on the ROs and/or RACH preamble indexes determined at step 410, a random access communication including a plurality of PRACH repetitions. The PRACH repetitions may be mapped to the ROs according to the random access communication described above. The PRACH repetitions may be transmitted by the UE 115 using one or more spatial filters as determined in step 408. In some aspects, the transmitting of the PRACH repetitions in step 412 includes transmitting a plurality of repetitions of a RACH MSG1. In some aspects, random access communication may be associated with a four-step RACH procedure (type-1) or a two-step RACH procedure (type-2).

At step 414, the BS 105 selects, based on the random access communication received at step 412, a PRACH detection hypothesis to detect and/or decode the random access communication. For example, the BS 105 may select the PRACH detection hypothesis based on a RO index of a detected PRACH, and/or based on a RACH preamble index of a detected PRACH. For example, if the BS 105 detects a PRACH communication in a first RO, which the BS 105 knows is configured for PRACH repetitions, the BS 105 may select a PRACH detection hypothesis that detects and/or decodes PRACH over a plurality of ROs configured for PRACH repetitions. In another example, if the BS 105 detects a PRACH communication in a second RO which the BS 105 knows is configured only for single PRACH transmissions, the BS 105 may select a PRACH detection hypothesis that detects and/or decodes PRACH based on single ROs.

In another example, if the BS 105 detects a PRACH communication indicating a first RACH preamble index, which the BS 105 knows is associated with PRACH repetitions, the BS 105 may select a PRACH detection hypothesis that detects and/or decodes PRACH over a plurality of ROs configured for PRACH repetitions. In another example, if the BS 105 detects a PRACH communication indicating a second RACH preamble which the BS 105 knows is associated only with single PRACH transmissions, the BS 105 may select a PRACH detection hypothesis that detects and/or decodes PRACH based on single ROs. Based on the selected detection hypothesis, the BS 105 may proceed to detect and/or decode the random access communication.

In another aspect, the selected PRACH detection hypothesis may be based on whether the random access communication indicates that the PRACH repetitions are transmitted using a same spatial filter, or different spatial filters. As explained above, one or both of the RO index or the RACH preamble index of the random access communication may indicate whether the PRACH repetitions are transmitted using a single spatial filter or multiple spatial filters. Accordingly, the BS 105 may select a PRACH detection hypothesis that either searches across multiple SSBs, or within single SSBs, to detect and decode the random access communication.

As explained above, the method 400 may be suitable for a four-step RACH procedure and/or a two-step RACH procedure. In this regard, steps 416 and 418 illustrate the method 400 according to a four-step RACH procedure (type-1). At step 416, based on detecting the random access communication received at step 412, the BS 105 transmits, and the UE 115 receives, a RACH MSG2, or random access response (RAR) including a grant of uplink (UL) resources. The MSG2 may indicate an RA-RNTI calculated based on the first symbol, slot, and carrier ID of the detected PRACH. In some aspects, the random access communication transmitted at step 412 may indicate, to the BS 105, whether the granted UL resources should include a grant for a single MSG3 (connection request), or multiple MSG3 repetitions. A random access communication including a plurality of repetitions of MSG1 (RACH preamble) may indicate that the UE 115 is requesting UL resources to transmit a plurality of repetitions of MSG3. The UE 115 transmits the MSG3, whether including a single MSG3 transmission or a plurality of MSG3 repetitions in step 418 based on the granted UL resources transmitted in step 416. In some aspects, the granted UL resources may include one or more physical uplink shared channels (PUSCHs).

At step 420, the BS 105 transmits, and the UE 115 receives, a RACH communication including one of MSG4 (if the RACH procedure is type-1), or MSGB (if the RACH procedure is type-2). Based on the RACH procedure performed in the method 400, the UE 115 and the BS 105 may perform communications, such as requesting UL resources for transmitting UL data, receiving DL data, and/or any other suitable communication.

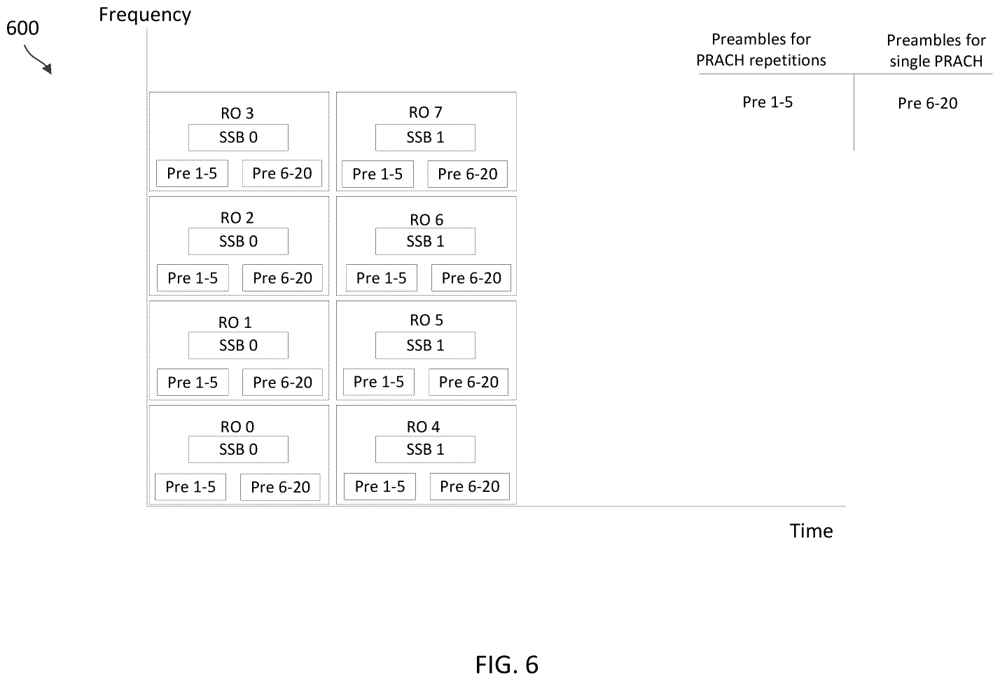

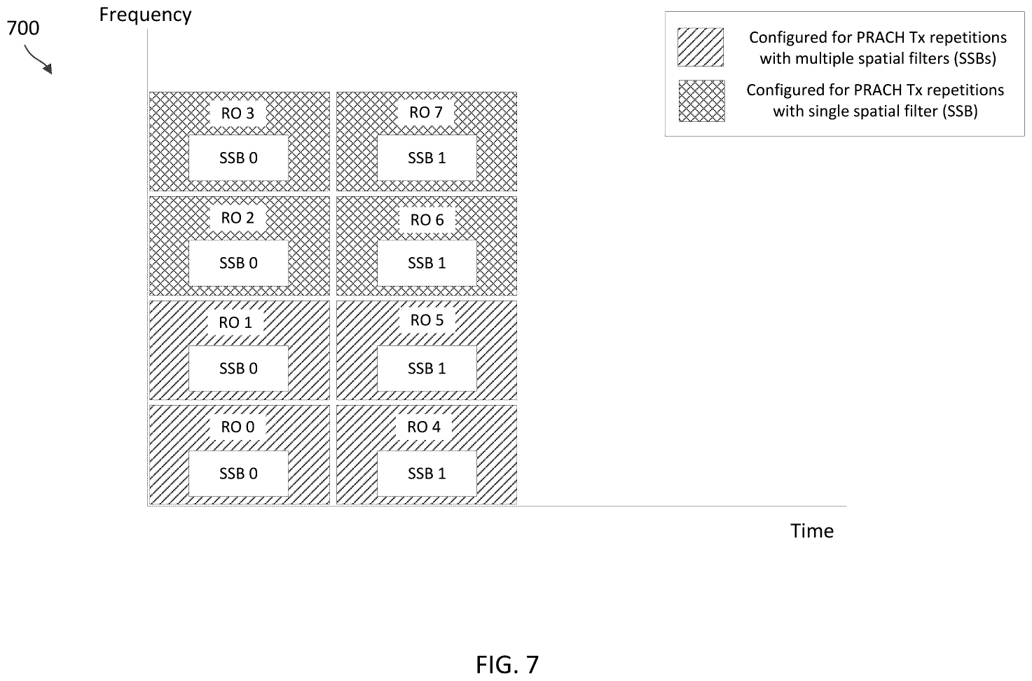

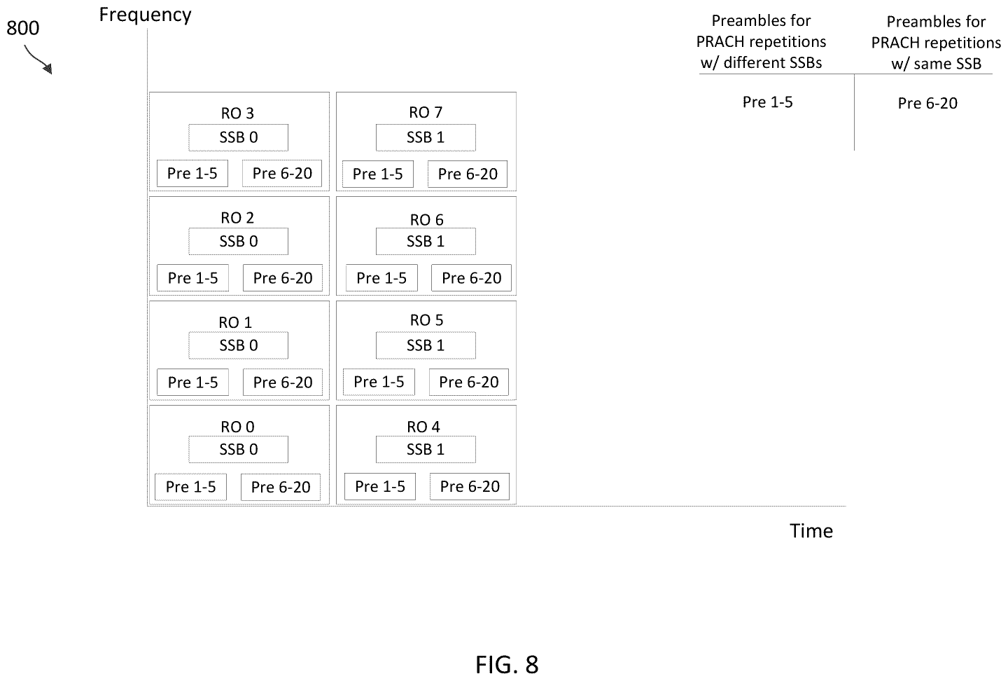

FIGS. 5-8 indicate various random access configuration schemes for indicating one or more aspects of a random access communication, including PRACH repetitions and/or multiple spatial filters. The configuration schemes may be used in the method 400, for example. FIGS. 5 and 6 illustrate configuration schemes 500, 600 for indicating whether a random access communication includes PRACH repetitions. FIGS. 7 and 8 illustrate configuration schemes 700, 800 for indicating whether PRACH repetitions are transmitted using a single spatial filter, or multiple spatial filters. The configuration schemes may be based on a random access configuration provided by a BS, such as the BS 105 in the method 400. The configuration schemes may be used by a UE, such as the UE 115 in the method 400, to map and transmit a RACH preamble to the BS using repetitions, and using one or more spatial filters, for example.

FIG. 5 illustrates a configuration scheme 500 for PRACH repetition indication using RO indexes. As explained above in the method 400, the random access configuration may indicate a first set of one or more ROs configured for PRACH repetitions. The random access configuration may also indicate a second set of one or more ROs configured for single PRACH transmissions. In the example of FIG. 5, the configuration indicates that the first two ROs associated with each of SSB 0 and SSB 1 are configured for PRACH repetitions. Accordingly, in the illustrated example, RO 0, RO 1, RO 4, and RO 5 are configured for PRACH repetitions. RO 2, RO 3, RO 6, and RO 7 are configured for single PRACH transmissions. In some aspects, the configuration may indicate each RO index configured for PRACH repetitions, and/or each RO index configured for single PRACH transmission. In another aspect, the configuration may indicate a number of ROs for each SSB index that are configured for PRACH repetitions. For example, the random access configuration may include a field indicating a number L, such that the first L repetitions in ascending order of RO index, is/are configured for PRACH repetitions.

FIG. 6 illustrates a configuration scheme 600 for PRACH repetition indication using RACH preamble indexes. As explained above in the method 400, the random access configuration may indicate a first set of one or more RACH preamble indexes associated with PRACH repetitions. The random access configuration may also indicate a second set of one or more RACH preamble indexes associated with single PRACH transmissions. In the example of FIG. 6, the configuration indicates that at least Preamble indexes 1-5 are associated with PRACH repetitions, and at least preamble indexes 6-20 are associated with single PRACH transmissions. For example, transmitting Preamble index 1 may indicate to the BS that the random access communication includes a plurality of PRACH repetitions. In some example, the PRACH repetitions may be mapped to ROs 0-3 using SSB 0. In another example, transmitting a PRACH with preamble index 6 may indicate that the PRACH is associated with a single PRACH transmission. In some aspects, the UE may be configured with a table indicating, for each RACH preamble index, whether the RACH preamble is associated with PRACH repetitions or single PRACH transmissions. It will be understood that the preamble index sets 1-5 and 6-20 are exemplary, and that any suitable grouping of preamble indexes may be used to indicate PRACH repetitions and/or single PRACH transmissions.

FIG. 7 illustrates a configuration scheme 700 for PRACH repetition indication using RO indexes. As explained above in the method 400, the random access configuration may indicate a first set of one or more ROs configured for PRACH repetitions using multiple spatial filters. The random access configuration may also indicate a second set of one or more ROs configured for PRACH repetitions using a single spatial filter. In the example of FIG. 7, the configuration indicates that the first two ROs associated with each of SSB 0 and SSB 1 are configured for PRACH repetitions using multiple spatial filters. Accordingly, in the illustrated example, RO 0, RO 1, RO 4, and RO 5 are configured for PRACH repetitions using multiple filters. RO 2, RO 3, RO 6, and RO 7 are configured for PRACH using a single spatial filter. In some aspects, the configuration may indicate each RO index configured for PRACH repetitions using multiple spatial filters, and/or each RO index configured for PRACH repetitions using a single filter. In another aspect, the configuration may further indicate a subset of one or more ROs configured for single PRACH transmission. In one aspect, the configuration may indicate a number of ROs for each SSB index that are configured for PRACH repetitions using multiple spatial filters. For example, the random access configuration may include a field indicating a number L, such that the first L repetitions in ascending order of RO index, is/are configured for PRACH repetitions using multiple spatial filters.

FIG. 8 illustrates a configuration scheme 800 for PRACH repetition indication using RACH preamble indexes. As explained above in the method 400, the random access configuration may indicate a first set of one or more RACH preamble indexes associated with PRACH repetitions using multiple spatial filters. The random access configuration may also indicate a second set of one or more RACH preamble indexes associated with PRACH repetitions using a single spatial filter. In the example of FIG. 8, the configuration indicates that at least Preamble indexes 1-5 are associated with PRACH repetitions using multiple spatial filters or SSBs, and that at least preamble indexes 6-20 are associated with PRACH repetitions using a same spatial filter or SSB. For example, the UE may map repetitions of Preamble index 1 to a first set of ROs associated with SSB 0 and a second set of ROs associated with SSB 1. The Preamble index 1 may indicate to the BS that the random access communication includes a plurality of PRACH repetitions mapped to ROs associated with more than on spatial filter. In some aspects, the UE may be configured with a table indicating, for each RACH preamble index, whether the RACH preamble is associated with PRACH repetitions using multiple spatial filters, PRACH repetitions using a single spatial filter, and/or single PRACH transmissions. It will be understood that the preamble index sets 1-5 and 6-20 are exemplary, and that any suitable grouping of preamble indexes may be used to indicate PRACH repetitions with different SSBs and/or PRACH repetitions with a same SSB.

FIG. 9 is a block diagram of an exemplary UE 900 according to some aspects of the present disclosure. The UE 900 may be a UE 115 in the network 100 as discussed above in FIG. 1. As shown, the UE 900 may include a processor 902, a memory 904, a random access module 908, a transceiver 910 including a modem subsystem 912 and a RF unit 914, and one or more antennas 916. These elements may be in direct or indirect communication with each other, for example via one or more buses.

The processor 902 may have various features as a specific-type processor. For example, these may include a CPU, a DSP, an ASIC, a controller, a FPGA device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 1102), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 904 may include a non-transitory computer-readable medium. The memory 904 may store instructions 906. The instructions 906 may include instructions that, when executed by the processor 902, cause the processor 902 to perform operations described herein, for example, aspects of FIGS. 3A-8 and 11. Instructions 906 may also be referred to as program code. The program code may be for causing a wireless communication device to perform these operations, for example by causing one or more processors (such as processor 1102) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The random access module 908 may be implemented via hardware, software, or combinations thereof. For example, the random access module 908 may be implemented as a processor, circuit, and/or instructions 906 stored in the memory 904 and executed by the processor 902. In some instances, the random access module 908 can be integrated within the modem subsystem 912. For example, the random access module 908 can be implemented by a combination of software components (e.g., executed by a DSP or a general processor) and hardware components (e.g., logic gates and circuitry) within the modem subsystem 912.

The random access module 908 may communicate with various components of the UE 900 to implement various aspects of the present disclosure, for example, aspects of FIGS. 3A-8 and 11. In some aspects, the random access module 908 is configured to receive, from a BS, one or more random access configurations associated with a plurality of random access occasions, where at least a first portion of the plurality of random access occasions is configured for PRACH message repetitions. In some aspects, all of the random access occasions may be configured for PRACH message repetitions. In other aspects, only a subset of the plurality of random access occasions may be configured for PRACH message repetitions. In some aspects, the random access module 908 is configured to system information in one or more transmissions indicating the one or more random access configurations. For example, the random access module 908 may be configured to receive a master information block (MIB), a system information block (SIB) message (e.g., SIB 1, SIB 2, etc.), and/or any other suitable system information. In some aspects, the one or more random access configurations includes one or more RRC information elements.

The one or more random access configurations may indicate one or more random access occasions and/or one or more random access preamble indexes associated with PRACH message repetitions. In other aspects, the one or more random access configurations may indicate one or more random access occasions and/or one or more random access preamble indexes associated with PRACH message repetitions with multiple spatial filters and/or single spatial filters.

The random access module 908 may be further configured to transmit, to the BS based on the one or more random access configurations, at least one random access communication, where the at least one random access communication includes a plurality of PRACH message repetitions in two or more of the plurality of random access occasions. Accordingly, at least one of a random access preamble index or a random access occasion index of the at least one random access communication may indicate, to the BS, whether the random access communication includes a single random access preamble transmission, or a plurality of PRACH message repetitions. In another aspect, at least one of a random access preamble index or a random access occasion index of the at least one random access communication may indicate, to the BS, whether the random access communication a plurality of PRACH message repetitions associated with multiple spatial filters, a plurality of PRACH message repetitions associated with a single spatial filter, or a single random access preamble transmission. In some aspects, transmitting the at least one random access communication includes transmitting a plurality of repetitions of a RACH preamble associated with a RACH preamble index. For example, transmitting the at least one random access communication may include transmitting a plurality of repetitions of MSG1 for a RACH type-1 procedure, or a plurality of repetitions of MSGA for a RACH type-2 procedure.

As shown, the transceiver 910 may include the modem subsystem 912 and the RF unit 914. The transceiver 910 can be configured to communicate bi-directionally with other devices, such as the BSs 105 and/or another core network element. The modem subsystem 912 may be configured to modulate and/or encode data according to a MCS, e.g., a LDPC coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data (e.g., RRC configuration, PRACH configurations, PDCCH signals, SSB, PDSCH signals, UL data) from the modem subsystem 912 (on outbound transmissions) or of transmissions originating from another source such as a BS 105. The RF unit 914 may be further configured to perform analog beamforming in conjunction with the digital beamforming. Although shown as integrated together in transceiver 910, the modem subsystem 912 and/or the RF unit 914 may be separate devices that are coupled together at the UE 115 to enable the UE 115 to communicate with other devices.

The RF unit 914 may provide the modulated and/or processed data, e.g. data packets (or, more generally, data messages that may contain one or more data packets and other information), to the antennas 916 for transmission to one or more other devices. This may include, for example, transmission of information to complete attachment to a network and communication with a BS 105 according to some aspects of the present disclosure. The antennas 916 may further receive data messages transmitted from other devices and provide the received data messages for processing and/or demodulation at the transceiver 910. The transceiver 910 may provide the demodulated and decoded data (e.g., PUSCH signals, PUCCH signals, SSB, PRACH, BCH) to the random access channel module 1108 for processing. The antennas 1116 may include multiple antennas of similar or different designs in order to sustain multiple transmission links.

In some aspects, the transceiver 910 is configured to communicate with other components of the UE 900 to transmit, to a BS, a random access preamble from the set of the sequences available in the cell to initiate communication to a BS (e.g., BS, 105). The transceiver 910 is further configured to communicate with other components of the UE 900 to transmit, to the BS in the set of the sequences of preambles and synchronization signals, an uplink synchronization signal comprising PRACH, and communicate, with the BS based on the PRACH, a communication signal in one or more component carriers of the set of component carriers.

In an aspect, the UE 900 can include multiple transceivers 910 implementing different RATs (e.g., NR and LTE). In an aspect, the UE 900 can include a single transceiver 910 implementing multiple RATs (e.g., NR and LTE). In an aspect, the transceiver 910 can include various components, where different combinations of components can implement different RATs.

FIG. 10 is a block diagram of an exemplary BS 1000 according to some aspects of the present disclosure. The BS 1000 may be a BS 105 as discussed above with respect to FIG. 1. As shown, the BS 1000 may include a processor 1002, a memory 1004, a random access module 1008, a transceiver 1010 including a modem subsystem 1012 and a radio frequency (RF) unit 1014, and one or more antennas 1016. These elements may be in direct or indirect communication with each other, for example via one or more buses.

The processor 1002 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1002 may also be implemented as a combination of computing devices, e.g., a combination of a DSP and a microprocessor, a plurality of microprocessors, one or more microprocessors in conjunction with a DSP core, or any other such configuration.

The memory 1004 may include a cache memory (e.g., a cache memory of the processor 1202), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 1004 includes a non-transitory computer-readable medium. The memory 1004 may store, or have recorded thereon, instructions 1006. The instructions 1006 may include instructions that, when executed by the processor 1002, cause the processor 1002 to perform the operations described herein with reference to the BSs 105 in connection with aspects of the present disclosure, for example, aspects of FIGS. 3A-8 and 12. Instructions 1006 may also be referred to as program code, which may be interpreted broadly to include any type of computer-readable statement(s) as discussed above with respect to FIG. 9.

The random access module 1008 may be implemented via hardware, software, or combinations thereof. For example, the random access module 1008 may be implemented as a processor, circuit, and/or instructions 1006 stored in the memory 1004 and executed by the processor 1002. In some instances, the random access module 1008 can be integrated within the modem subsystem 1012. For example, the random access module 1008 can be implemented by a combination of software components (e.g., executed by a DSP or a general processor) and hardware components (e.g., logic gates and circuitry) within the modem subsystem 1012.

The random access module 1008 may communicate various components of the BS 1000 to implement various aspects of the present disclosure, for example, aspects of FIGS. 3A-8. In some aspects, the random access module 1008 is configured to transmit, to a UE, one or more random access configurations associated with a plurality of random access occasions, where at least a first portion of the plurality of random access occasions is configured for PRACH message repetitions. In some aspects, all of the random access occasions may be configured for PRACH message repetitions. In other aspects, only a subset of the plurality of random access occasions may be configured for PRACH message repetitions. In some aspects, the random access module 908 is configured to transmit system information in one or more transmissions indicating the one or more random access configurations. For example, the random access module 908 may be configured to transmit a master information block (MIB), a system information block (SIB) message (e.g., SIB 1, SIB 2, etc.), and/or any other suitable system information. In some aspects, the one or more random access configurations includes one or more RRC information elements.

The one or more random access configurations may indicate one or more random access occasions and/or one or more random access preamble indexes associated with PRACH message repetitions. In other aspects, the one or more random access configurations may indicate one or more random access occasions and/or one or more random access preamble indexes associated with PRACH message repetitions with multiple spatial filters and/or single spatial filters.

The random access module 1008 may be further configured to receive, from the UE based on the one or more random access configurations, at least one random access communication, where the at least one random access communication includes a plurality of PRACH message repetitions in two or more of the plurality of random access occasions. Accordingly, at least one of a random access preamble index or a random access occasion index of the at least one random access communication may indicate, to the random access module 1008, whether the random access communication includes a single random access preamble transmission, or a plurality of PRACH message repetitions. In another aspect, at least one of a random access preamble index or a random access occasion index of the at least one random access communication may indicate, to the BS, whether the random access communication a plurality of PRACH message repetitions associated with multiple spatial filters, a plurality of PRACH message repetitions associated with a single spatial filter, or a single random access preamble transmission. In some aspects, transmitting the at least one random access communication includes transmitting a plurality of repetitions of a RACH preamble associated with a RACH preamble index. For example, transmitting the at least one random access communication may include transmitting a plurality of repetitions of MSG1 for a RACH type-1 procedure, or a plurality of repetitions of MSGA for a RACH type-2 procedure.

As shown, the transceiver 1010 may include the modem subsystem 1012 and the RF unit 1014. The transceiver 1010 can be configured to communicate bi-directionally with other devices, such as the UEs 115. The modem subsystem 1012 may be configured to modulate and/or encode the data from the memory 1004 and/or the random access module 1008 according to a modulation and coding scheme (MCS), e.g., a low-density parity check (LDPC) coding scheme, a turbo coding scheme, a convolutional coding scheme, a digital beamforming scheme, etc. The RF unit 1014 may be configured to process (e.g., perform analog to digital conversion or digital to analog conversion, etc.) modulated/encoded data (e.g., PUSCH signals, PUCCH signals) from the modem subsystem 1012 (on outbound transmissions) or of transmissions originating from another source such as a UE 115 or a BS 105. The RF unit 1014 may be further configured to perform analog beamforming in conjunction with the digital beamforming. Although shown as integrated together in transceiver 1010, the modem subsystem 1012 and the RF unit 1014 may be separate devices that are coupled together at the BS 105 to enable the UE 115 to communicate with other devices.

The RF unit 1014 may provide the modulated and/or processed data, e.g. data packets (or, more generally, data messages that may include one or more data packets and other information), to the antennas 1016 for transmission to one or more other devices. The antennas 1016 may further receive data messages transmitted from other devices. The antennas 1016 may provide the received data messages for processing and/or demodulation at the transceiver 1010. The transceiver 1010 may provide the demodulated and decoded data (e.g., RRC configuration, PRACH configurations, PDCCH signals, SIB, PDSCH signals, BCH Signals, DL data) to the random access module 1008 for processing. The antennas 1016 may include multiple antennas of similar or different designs in order to sustain multiple transmission links. The RF unit 1014 may configure the antennas 1016.

In an aspect, the BS 1000 can include multiple transceivers 1010 implementing different RATs (e.g., NR and LTE). In an aspect, the BS 1000 can include a single transceiver 1010 implementing multiple RATs (e.g., NR and LTE). In an aspect, the transceiver 1010 can include various components, where different combinations of components can implement different RATs.

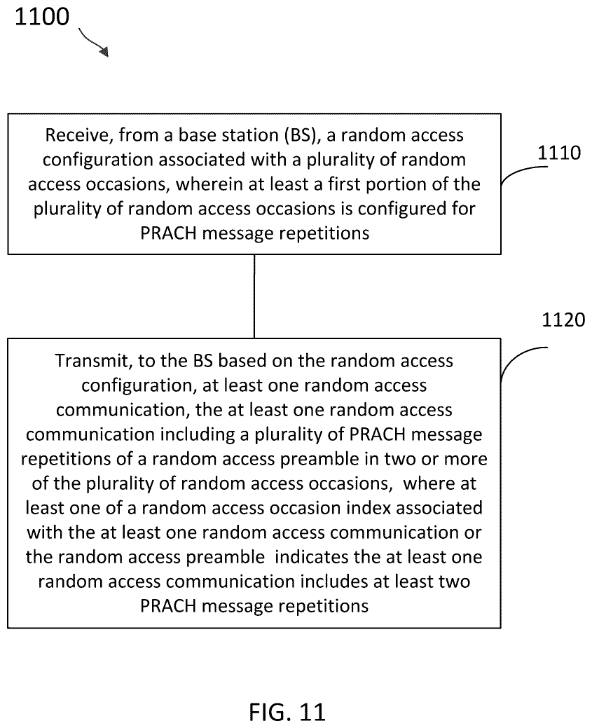

FIG. 11 is a flow diagram of a wireless communication method 1100 according to some aspects of the present disclosure. Aspects of the method 1100 can be executed by a computing device (e.g., a processor, processing circuit, and/or other suitable component) of a wireless communication device or other suitable means for performing the steps. For example, a wireless communication device, such as a UE 115 or the UE 900, may utilize one or more components, such as the processor 902, the memory 904, the random access module 908, the transceiver 910, the modem 912, and the one or more antennas 916, to execute the steps of method 1100. The method 1100 may employ similar mechanisms as described above in FIGS. 3A-8. As illustrated, the method 1100 includes a number of enumerated steps, but aspects of the method 1100 may include additional steps before, after, and in between the enumerated steps. In some aspects, one or more of the enumerated steps may be omitted or performed in a different order.

At block 1110, the UE receives, from a BS, one or more random access configurations associated with a plurality of random access occasions, where at least a first portion of the plurality of random access occasions is configured for PRACH message repetitions. In some aspects, all of the random access occasions may be configured for PRACH message repetitions. In other aspects, only a subset of the plurality of random access occasions may be configured for PRACH message repetitions. In some aspects, receiving the one or more random access configurations includes receiving system information in one or more transmissions. For example, receiving the one or more random access configurations may include receiving a master information block (MIB), a system information block (SIB) message (e.g., SIB 1, SIB 2, etc.), and/or any other suitable system information. In some aspects, receiving the one or more random access configurations includes receiving one or more RRC information elements. In some aspects, receiving the one or more random access configurations includes receiving one or more MAC control elements and/or information elements.

The one or more random access configurations may include or indicate a plurality of parameters or fields. For example, the one or more random access configurations may indicate a number of SSB indexes corresponding to each of one or more RACH occasions (ROs) in an association period. The one or more random access configurations may indicate a number of SSBs or spatial filters per RO, the number of PRACH frequency domain multiplexed (FDM) in the association period, and the number of SSBs mapped to the ROs in the association period. The number of SSBs/RO may be a fractional value (e.g., ⅛, ¼, ½), 1, or an integer greater than one (e.g., 1, 2, 4, 8). The SSB indexes may be mapped to the ROs first, in increasing order of preamble indexes within a single RO; second, in increasing order of frequency resource indexes for frequency multiplexed (FDM) RACH occasions; third, in increasing order of time resource indexes for time multiplexed RACH occasions within a PRACH slot; and fourth, in increasing order of indexes for PRACH slots. In some aspects, the number of SSB/RO and the number of preambles per SSB may be provided by ssb-perRACH-OccasionANDCB-PreamblesPerSSB indicated in RACH-ConfigCommon. The number of ROs frequency multiplexed may be provided by MSG1-FDM in RACH-ConfigGeneric, for example. The number of SSBs mapped to a set of ROs in an association period may be provided by ssb-PositionsInBurst in SIB1 or in ServingCellConfigommon, for example.

In another aspect, the one or more random access configurations indicate the first portion of the random access occasions is configured for PRACH message repetitions and a second portion of the random access occasions is not configured for PRACH message repetitions. In another aspect, the random access occasion index of the at least one random access communication may be associated with the first portion of the random access occasions and indicates the at least one random access communication includes at least two PRACH message repetitions. For example, the one or more random access configurations may indicate a first set of one or more ROs configured for PRACH repetitions. The one or more random access configurations may also indicate a second set of one or more ROs configured for single PRACH transmissions. For example, the one or more random access configurations may include or indicate one or more parameters or fields indicating one or more RO indexes associated with PRACH repetitions. The one or more random access configurations may indicate, for each SSB, a subset of ROs corresponding to the SSB configured for PRACH repetitions. In another aspect, the one or more random access configurations may indicate an integer value L associated with the number of ROs, for each SSB, configured for PRACH transmissions. For example, the value L may indicate that the first L ROs corresponding to SSB N are configured for PRACH repetitions, or that the last L ROs corresponding to SSB N are configured for PRACH repetitions.

In another aspect, the one or more random access configurations may indicate a first set of one or more RACH preamble indexes associated with PRACH repetitions. The one or more random access configurations may also indicate a second set of one or more RACH preamble indexes associated with single PRACH transmissions. For example, the one or more random access configurations may include or indicate one or more parameters or fields indicating one or more RACH preamble indexes associated with PRACH repetitions.

In another aspect, the one or more random access configurations may indicate a first set of one or more ROs configured for PRACH repetitions using more than one spatial filter or SSB. The one or more random access configurations may also indicate a second set of one or more ROs configured for PRACH repetitions using a single spatial filter or SSB. For example, the one or more random access configurations may include or indicate one or more parameters or fields indicating one or more RO indexes associated with PRACH repetitions that can be transmitted using two or more spatial filters. For example, in some aspects, the one or more random access configurations may indicate: the first portion of the random access occasions is configured for PRACH message repetitions using a same spatial filter; and a second portion of the random access occasions is configured for PRACH message repetitions using a plurality of spatial filters. For example, a first spatial filter associated with a first occasion of the second portion of random access occasions may be different from a second spatial filter associated with a second occasion of the second portion of random access occasions.

In another aspect, the one or more random access configurations may indicate a first set of one or more RACH preamble indexes associated with PRACH transmissions using more than one spatial filter or SSB. The one or more random access configurations may also indicate a second set of one or more RACH preamble indexes associated with PRACH repetitions using a single spatial filter or SSB. For example, the one or more random access configurations may include or indicate one or more parameters or fields indicating one or more RACH preamble indexes associated with PRACH repetitions that can be transmitted using two or more spatial filters. For example, the one or more random access configurations may indicate: a first plurality of random access preamble indexes configured for PRACH message repetitions using a same spatial filter; and a second plurality of random access preamble indexes configured for PRACH message repetitions using a plurality of spatial filters. For example, a first spatial filter associated with a first preamble index of the second plurality of random access preamble indexes may be different from a second spatial filter associated with a second preamble index of the second plurality of random access preamble indexes.

In another aspect, the one or more random access configurations may indicate that the plurality of random access occasions are associated with a type-1 RACH procedure. In another aspect, the one or more random access configurations may indicate that the plurality of random access occasions are associated with a type-2 RACH procedure. In another aspect, the one or more random access configurations may indicate that the plurality of random access occasions are shared between associated with both a type-1 and type-2 RACH procedure.

At block 1120, the UE transmits, to the BS based on the one or more random access configurations, at least one random access communication, where the at least one random access communication includes a plurality of PRACH message repetitions in two or more of the plurality of random access occasions. In some aspects, transmitting the at least one random access communication includes transmitting a plurality of repetitions of a RACH preamble associated with a RACH preamble index. For example, transmitting the at least one random access communication may include transmitting a plurality of repetitions of MSG1 for a RACH type-1 procedure, or a plurality of repetitions of MSGA for a RACH type-2 procedure.

In some aspects, the random access communication may implicitly indicate, to the BS, to grant UL resources sufficient for a plurality of repetitions of a RACH MSG3 (connection request). Accordingly, the BS may transmit a RAR including a UL grant for a plurality of repetitions.

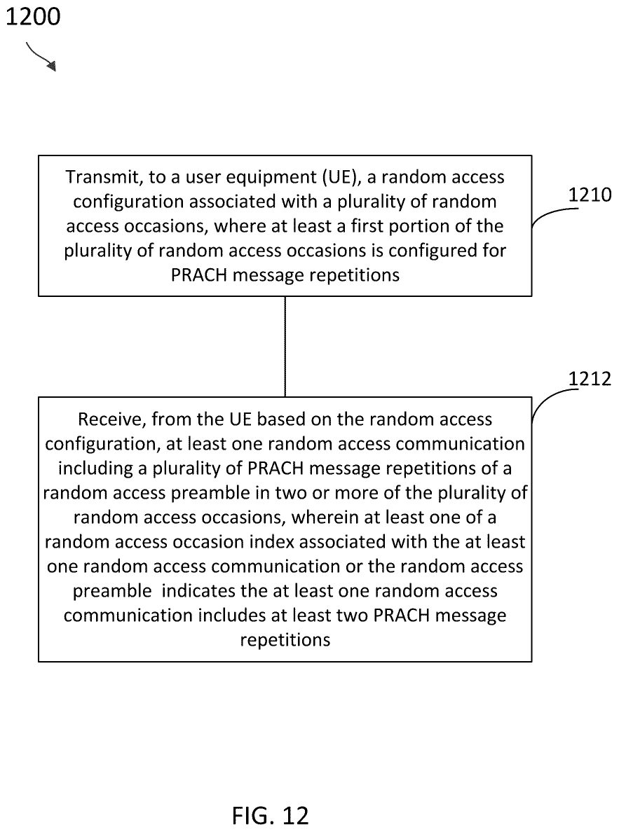

FIG. 12 is a flow diagram of a wireless communication method 1200 according to some aspects of the present disclosure. Aspects of the method 1200 can be executed by a computing device (e.g., a processor, processing circuit, and/or other suitable component) of a wireless communication device or other suitable means for performing the steps. For example, a wireless communication device, such as a BS 105 or the BS 1000, may utilize one or more components, such as the processor 1002, the memory 1004, the random access module 1008, the transceiver 1010, the modem 1012, and the one or more antennas 1016, to execute the steps of method 1200. The method 1200 may employ similar mechanisms as described above in FIGS. 3A-8. As illustrated, the method 1200 includes a number of enumerated steps, but aspects of the method 1200 may include additional steps before, after, and in between the enumerated steps. In some aspects, one or more of the enumerated steps may be omitted or performed in a different order.

At block 1210, the BS transmits, to a UE, one or more random access configurations associated with a plurality of random access occasions, where at least a first portion of the plurality of random access occasions is configured for PRACH message repetitions. In some aspects, all of the random access occasions may be configured for PRACH message repetitions. In other aspects, only a subset of the plurality of random access occasions may be configured for PRACH message repetitions. In some aspects, receiving the one or more random access configurations includes receiving system information in one or more transmissions. For example, transmitting the one or more random access configurations may include transmitting a master information block (MIB), a system information block (SIB) message (e.g., SIB 1, SIB 2, etc.), and/or any other suitable system information. In some aspects, transmitting the one or more random access configurations includes receiving one or more RRC information elements. In some aspects, transmitting the one or more random access configurations includes receiving one or more MAC control elements and/or information elements.

The one or more random access configurations may include or indicate a plurality of parameters or fields. For example, the one or more random access configurations may indicate a number of SSB indexes corresponding to each of one or more RACH occasions (ROs) in an association period. The one or more random access configurations may indicate a number of SSBs or spatial filters per RO, the number of PRACH frequency domain multiplexed (FDM) in the association period, and the number of SSBs mapped to the ROs in the association period. The number of SSBs/RO may be a fractional value (e.g., ⅛, ¼, ½), 1, or an integer greater than one (e.g., 1, 2, 4, 8). The SSB indexes may be mapped to the ROs first, in increasing order of preamble indexes within a single RO; second, in increasing order of frequency resource indexes for frequency multiplexed (FDM) RACH occasions; third, in increasing order of time resource indexes for time multiplexed RACH occasions within a PRACH slot; and fourth, in increasing order of indexes for PRACH slots. In some aspects, the number of SSB/RO and the number of preambles per SSB may be provided by ssb-perRACH-OccasionANDCB-PreamblesPerSSB indicated in RACH-ConfigCommon. The number of ROs frequency multiplexed may be provided by MSG1-FDM in RACH-ConfigGeneric, for example. The number of SSBs mapped to a set of ROs in an association period may be provided by ssb-PositionsInBurst in SIB1 or in ServingCellConfigommon, for example.

In another aspect, the one or more random access configurations indicate the first portion of the random access occasions is configured for PRACH message repetitions and a second portion of the random access occasions is not configured for PRACH message repetitions. In another aspect, the random access occasion index of the at least one random access communication may be associated with the first portion of the random access occasions and indicates the at least one random access communication includes at least two PRACH message repetitions. For example, the one or more random access configurations may indicate a first set of one or more ROs configured for PRACH repetitions. The one or more random access configurations may also indicate a second set of one or more ROs configured for single PPRACH transmissions. For example, the one or more random access configurations may include or indicate one or more parameters or fields indicating one or more RO indexes associated with PRACH repetitions. The one or more random access configurations may indicate, for each SSB, a subset of ROs corresponding to the SSB configured for PRACH repetitions. In another aspect, the one or more random access configurations may indicate an integer value L associated with the number of ROs, for each SSB, configured for PRACH transmissions. For example, the value L may indicate that the first L ROs corresponding to SSB N are configured for PRACH repetitions, or that the last L ROs corresponding to SSB N are configured for PRACH repetitions.

In another aspect, the one or more random access configurations may indicate a first set of one or more RACH preamble indexes associated with PRACH repetitions. The one or more random access configurations may also indicate a second set of one or more RACH preamble indexes associated with single PRACH transmissions. For example, the one or more random access configurations may include or indicate one or more parameters or fields indicating one or more RACH preamble indexes associated with PRACH repetitions.

In another aspect, the one or more random access configurations may indicate a first set of one or more ROs configured for PRACH repetitions using more than one spatial filter or SSB. The one or more random access configurations may also indicate a second set of one or more ROs configured for PRACH repetitions using a single spatial filter or SSB. For example, the one or more random access configurations may include or indicate one or more parameters or fields indicating one or more RO indexes associated with PRACH repetitions that can be transmitted using two or more spatial filters. For example, in some aspects, the one or more random access configurations may indicate: the first portion of the random access occasions is configured for PRACH message repetitions using a same spatial filter; and a second portion of the random access occasions is configured for PRACH message repetitions using a plurality of spatial filters such that a first spatial filter associated with a first occasion of the second portion of random access occasions is different from a second spatial filter associated with a second occasion of the second portion of random access occasions.

In another aspect, the one or more random access configurations may indicate a first set of one or more RACH preamble indexes associated with PRACH transmissions using more than one spatial filter or SSB. The one or more random access configurations may also indicate a second set of one or more RACH preamble indexes associated with PRACH repetitions using a single spatial filter or SSB. For example, the one or more random access configurations may include or indicate one or more parameters or fields indicating one or more RACH preamble indexes associated with PRACH repetitions that can be transmitted using two or more spatial filters. For example, the one or more random access configurations may indicate: a first plurality of random access preamble indexes configured for PRACH message repetitions using a same spatial filter; and a second plurality of random access preamble indexes configured for PRACH message repetitions using a plurality of spatial filters such that a first spatial filter associated with a first preamble of the second plurality of random access preamble indexes is different from a second spatial filter associated with a second preamble of the second plurality of random access preamble indexes.

In another aspect, the one or more random access configurations may indicate that the plurality of random access occasions are associated with a type-1 RACH procedure. In another aspect, the one or more random access configurations may indicate that the plurality of random access occasions are associated with a type-2 RACH procedure. In another aspect, the one or more random access configurations may indicate that the plurality of random access occasions are shared between associated with both a type-1 and type-2 RACH procedure.

At block 1220, the BS receives, from the UE based on the one or more random access configurations, at least one random access communication, where the at least one random access communication includes a plurality of PRACH message repetitions in two or more of the plurality of random access occasions. In some aspects, receiving the at least one random access communication includes receiving a plurality of repetitions of a RACH preamble associated with a RACH preamble index. For example, receiving the at least one random access communication may include transmitting a plurality of repetitions of MSG1 for a RACH type-1 procedure, or a plurality of repetitions of MSGA for a RACH type-2 procedure.

In some aspects, the random access communication may implicitly indicate, to the BS, to grant UL resources sufficient for a plurality of repetitions of a RACH MSG3 (connection request). Accordingly, the BS may transmit a RAR including a UL grant for a plurality of repetitions.

### EXEMPLARY ASPECTS OF THE DISCLOSURE

Aspect 1. A method of wireless communication performed by a user equipment (UE), the method comprising: receiving, from a base station (BS), a random access configuration associated with a plurality of random access occasions, wherein at least a first portion of the plurality of random access occasions is configured for PRACH message repetitions; and transmitting, to the BS based on the random access configuration, at least one random access communication, the at least one random access communication including a plurality of PRACH message repetitions in two or more of the plurality of random access occasions, wherein at least one of a random access occasion index associated with the at least one random access communication or the random access preamble indicates the at least one random access communication includes at least two PRACH message repetitions.
Aspect 2. The method of aspect 1, wherein the random access configuration indicates the first portion of the random access occasions is configured for PRACH message repetitions and a second portion of the random access occasions is not configured for PRACH message repetitions.
Aspect 3. The method of aspect 2, wherein the random access occasion index of the at least one random access communication is associated with the first portion of the random access occasions and indicates the at least one random access communication includes at least two PRACH message repetitions.
Aspect 4. The method of any of aspects 1-3, wherein the random access configuration indicates a first plurality of random access preamble indexes configured for PRACH message repetitions and a second plurality of random access preamble indexes not configured for PRACH message repetitions.
Aspect 5. The method of aspect 4, wherein the random access preamble of the at least one random access communication is associated with the first plurality of random access preamble indexes and indicates the at least one random access communication includes at least two PRACH message repetitions.
Aspect 6. The method of any of aspects 1-5, wherein the random access configuration indicates: the first portion of the random access occasions is configured for PRACH message repetitions using a same spatial filter; and a second portion of the random access occasions is configured for PRACH message repetitions using a plurality of spatial filters such that a first spatial filter associated with a first occasion of the second portion of random access occasions is different from a second spatial filter associated with a second occasion of the second portion of random access occasions.
Aspect 7. The method of any of aspects 1-6, wherein the random access configuration indicates a first plurality of random access preamble indexes configured for PRACH message repetitions using a same spatial filter; and a second plurality of random access preamble indexes is configured for PRACH message repetitions using a plurality of spatial filters.
Aspect 8. The method of any of aspects 1-7, wherein at least one of the random access occasion index associated with the at least one random access communication or the random access preamble implicitly indicates a request for uplink (UL) resources for a plurality of UL shared channel repetitions.
Aspect 9. The method of any of aspects 1-8, wherein the random access configuration indicates the plurality of random access occasions are associated with a type-1 random access channel (RACH) procedure.
Aspect 10. The method of any of aspects 1-8, wherein the random access configuration indicates the plurality of random access occasions are associated with a type-2 random access channel (RACH) procedure.
Aspect 11. The method of any of aspects 1-8, wherein the random access configuration indicates the plurality of random access occasions are associated with both type-1 and type-2 random access channel (RACH) procedures.
Aspect 12. A method of wireless communication performed by a base station (BS), the method comprising: transmitting, to a user equipment (UE), a random access configuration associated with a plurality of random access occasions, wherein at least a first portion of the plurality of random access occasions is configured for PRACH message repetitions; and receiving, from the UE based on the random access configuration, at least one random access communication the at least one random access communication including a plurality of PRACH message repetitions in two or more of the plurality of random access occasions, wherein at least one of a random access occasion index associated with the at least one random access communication or the random access preamble indicates the at least one random access communication includes at least two PRACH message repetitions.
Aspect 13. The method of aspect 12, wherein the random access configuration indicates the first portion of the random access occasions is configured for PRACH message repetitions and a second portion of the random access occasions is not configured for PRACH message repetitions.
Aspect 14. The method of aspect 13, wherein the random access occasion index of the at least one random access communication is associated with the first portion of the random access occasions.
Aspect 15. The method of any of aspects 12-14, wherein the random access configuration indicates a first plurality of random access preamble indexes configured for PRACH message repetitions and a second plurality of random access preamble indexes not configured for PRACH message repetitions.
Aspect 16. The method of aspect 15, wherein the random access preamble of the at least one random access communication is associated with the first plurality of random access preamble indexes.
Aspect 17. The method of any of aspects 12-16, wherein the random access configuration indicates: the first portion of the random access occasions is configured for PRACH message repetitions using a same spatial filter; and a second portion of the random access occasions is configured for PRACH message repetitions using a plurality of spatial filters.
Aspect 18. The method of any of aspects 12-17, wherein the random access configuration indicates: a first plurality of random access preamble indexes configured for PRACH message repetitions using a same spatial filter; and a second plurality of random access preamble indexes is configured for PRACH message repetitions using a plurality of spatial filters such that a first spatial filter associated with a first preamble of the second plurality of random access preamble indexes is different from a second spatial filter associated with a second preamble of the second plurality of random access preamble indexes.
Aspect 19. The method of any of aspects 12-18, wherein at least one of the random access occasion index associated with the at least one random access communication or the random access preamble implicitly indicates a request for uplink (UL) resources for a plurality of UL shared channel repetitions.
Aspect 20. The method of any of aspects 12-19, wherein the random access configuration indicates the plurality of random access occasions are associated with a type-1 random access channel (RACH) procedure.
Aspect 21. The method of any of aspects 12-19, wherein the random access configuration indicates the plurality of random access occasions are associated with a type-2 random access channel (RACH) procedure.
Aspect 22. The method of any of aspects 12-19, wherein the random access configuration indicates the plurality of random access occasions are associated with both type-1 and type-2 random access channel (RACH) procedures.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method of wireless communication performed by a user equipment (UE), the method comprising:
receiving, from a base station (BS), a random access configuration associated with a plurality of random access occasions, wherein at least a first portion of the plurality of random access occasions is configured for preamble random access channel (PRACH) message repetitions; and
transmitting, to the BS based on the random access configuration, at least one random access communication, the at least one random access communication including a plurality of PRACH message repetitions of a random access preamble in two or more of the plurality of random access occasions,
wherein at least one of a random access occasion index associated with the at least one random access communication or the random access preamble indicates that the at least one random access communication includes at least two PRACH message repetitions.

2. The method of claim 1, wherein the random access configuration indicates that the first portion of the plurality of random access occasions is configured for PRACH message repetitions and a second portion of the plurality of random access occasions is not configured for PRACH message repetitions.

3. The method of claim 2, wherein the random access occasion index of the at least one random access communication is associated with the first portion of the plurality of random access occasions and indicates the at least one random access communication includes the at least two PRACH message repetitions.

4. The method of claim 1, wherein the random access configuration indicates a first plurality of random access preamble indexes configured for PRACH message repetitions and a second plurality of random access preamble indexes not configured for PRACH message repetitions.

5. The method of claim 4, wherein the random access preamble of the at least one random access communication is associated with the first plurality of random access preamble indexes and indicates the at least one random access communication includes the at least two PRACH message repetitions.

6. The method of claim 1, wherein the random access configuration indicates that:
the first portion of the plurality of random access occasions is configured for PRACH message repetitions using a same spatial filter; and
a second portion of the plurality of random access occasions is configured for PRACH message repetitions using a plurality of spatial filters such that a first spatial filter associated with a first occasion of the second portion of the plurality of random access occasions is different from a second spatial filter associated with a second occasion of the second portion of the plurality of random access occasions.

7. The method of claim 1, wherein the random access configuration indicates:
a first plurality of random access preamble indexes configured for PRACH message repetitions using a same spatial filter; and
a second plurality of random access preamble indexes configured for PRACH message repetitions using a plurality of spatial filters.

8. The method of claim 1, wherein at least one of the random access occasion index associated with the at least one random access communication or the random access preamble implicitly indicates a request for uplink (UL) resources for a plurality of UL shared channel repetitions.

9. The method of claim 1, wherein the random access configuration indicates the plurality of random access occasions are associated with a type-1 random access channel (RACH) procedure.

10. The method of claim 1, wherein the random access configuration indicates the plurality of random access occasions are associated with a type-2 random access channel (RACH) procedure.

11. The method of claim 1, wherein the random access configuration indicates the plurality of random access occasions are associated with both type-1 and type-2 random access channel (RACH) procedures.

12. A method of wireless communication performed by a base station (BS), the method comprising:
transmitting, to a user equipment (UE), a random access configuration associated with a plurality of random access occasions, wherein at least a first portion of the plurality of random access occasions is configured for preamble random access channel (PRACH) message repetitions; and
receiving, from the UE based on the random access configuration, at least one random access communication the at least one random access communication including a plurality of PRACH message repetitions of a random access preamble in two or more of the plurality of random access occasions,
wherein at least one of a random access occasion index associated with the at least one random access communication or the random access preamble indicates that the at least one random access communication includes at least two PRACH message repetitions.

13. The method of claim 12, wherein the random access configuration indicates that the first portion of the plurality of random access occasions is configured for PRACH message repetitions and a second portion of the plurality of random access occasions is not configured for PRACH message repetitions.

14. The method of claim 13, wherein the random access occasion index of the at least one random access communication is associated with the first portion of the plurality of random access occasions.

15. The method of claim 12, wherein the random access configuration indicates a first plurality of random access preamble indexes configured for PRACH message repetitions and a second plurality of random access preamble indexes not configured for PRACH message repetitions.

16. The method of claim 15, wherein the random access preamble of the at least one random access communication is associated with the first plurality of random access preamble indexes.

17. The method of claim 12, wherein the random access configuration indicates that:
the first portion of the plurality of random access occasions is configured for PRACH message repetitions using a same spatial filter; and
a second portion of the plurality of random access occasions is configured for PRACH message repetitions using a plurality of spatial filters.

18. The method of claim 12, wherein the random access configuration indicates:
a first plurality of random access preamble indexes configured for PRACH message repetitions using a same spatial filter; and
a second plurality of random access preamble indexes is configured for PRACH message repetitions using a plurality of spatial filters such that a first spatial filter associated with a first preamble of the second plurality of random access preamble indexes is different from a second spatial filter associated with a second preamble of the second plurality of random access preamble indexes.

19. The method of claim 12, wherein at least one of the random access occasion index associated with the at least one random access communication or the random access preamble implicitly indicates a request for uplink (UL) resources for a plurality of UL shared channel repetitions.

20. The method of claim 12, wherein the random access configuration indicates the plurality of random access occasions are associated with a type-1 random access channel (RACH) procedure.

21. The method of claim 12, wherein the random access configuration indicates the plurality of random access occasions are associated with a type-2 random access channel (RACH) procedure.

22. The method of claim 12, wherein the random access configuration indicates the plurality of random access occasions are associated with both type-1 and type-2 random access channel (RACH) procedures.

23. A user equipment (UE), comprising:
a transceiver and a processor in communication with the transceiver, wherein the processor and the transceiver are configured to:
receive, from a base station (BS), a random access configuration associated with a plurality of random access occasions, wherein at least a first portion of the plurality of random access occasions is configured for preamble random access channel (PRACH) message repetitions; and
transmit, to the BS based on the random access configuration, at least one random access communication, the at least one random access communication including a plurality of PRACH message repetitions of a random access preamble in two or more of the plurality of random access occasions,
wherein at least one of a random access occasion index associated with the at least one random access communication or the random access preamble indicates that the at least one random access communication includes at least two PRACH message repetitions.

24. The UE of claim 23, wherein the random access configuration indicates that the first portion of the plurality of random access occasions is configured for PRACH message repetitions and a second portion of the plurality of random access occasions is not configured for PRACH message repetitions.

25. The UE of claim 23, wherein the random access configuration indicates a first plurality of random access preamble indexes configured for PRACH message repetitions and a second plurality of random access preamble indexes not configured for PRACH message repetitions.

26. The UE of claim 23, wherein the random access configuration indicates that:
the first portion of the plurality of random access occasions is configured for PRACH message repetitions using a same spatial filter; and
a second portion of the plurality of random access occasions is configured for PRACH message repetitions using a plurality of spatial filters such that a first spatial filter associated with a first occasion of the second portion of the plurality of random access occasions is different from a second spatial filter associated with a second occasion of the second portion of the plurality of random access occasions.

27. A base station (BS), comprising:
a transceiver and a processor in communication with the transceiver, wherein the processor and the transceiver are configured to:
transmit, to a user equipment (UE), a random access configuration associated with a plurality of random access occasions, wherein at least a first portion of the plurality of random access occasions is configured for preamble random access channel (PRACH) message repetitions; and
receive, from the UE based on the random access configuration, at least one random access communication including a plurality of PRACH message repetitions of a random access preamble in two or more of the plurality of random access occasions,
wherein at least one of a random access occasion index associated with the at least one random access communication or the random access preamble indicates that the at least one random access communication includes at least two PRACH message repetitions.

28. The BS of claim 27, wherein the random access configuration indicates that the first portion of the plurality of random access occasions is configured for PRACH message repetitions and a second portion of the plurality of random access occasions is not configured for PRACH message repetitions.

29. The BS of claim 27, wherein the random access configuration indicates a first plurality of random access preamble indexes configured for PRACH message repetitions and a second plurality of random access preamble indexes not configured for PRACH message repetitions.

30. The BS of claim 27, wherein the random access configuration indicates that:
the first portion of the plurality of random access occasions is configured for PRACH message repetitions using a same spatial filter; and
a second portion of the plurality of random access occasions is configured for PRACH message repetitions using a plurality of spatial filters such that a first spatial filter associated with a first occasion of the second portion of the plurality of random access occasions is different from a second spatial filter associated with a second occasion of the second portion of the plurality of random access occasions.
